(19) United States
(12) Patent Application Publication
(10) Pub. No.: US 2016/0299647 A1
(43) Pub. Date: Oct. 13, 2016

(54) METHOD TO OPTIMIZE THE USER INTERFACE TO MANAGE MULTIPLE COMMUNICATIONS ON A COMMUNICATIONS APPLICATION

(71) Applicant: Avaya Inc., Santa Clara, CA (US)

(72) Inventors: Jason Tanabe, Ontario (CA); Ron Gagnier, Ontario (CA); Justin Baltazor, Brentwood, CA (US); Tim Rahrer, Ontario (CA); Marcel Naegelkraemer, Ontario (CA)

(21) Appl. No.: 14/681,449

(22) Filed: Apr. 8, 2015

(51) Int. Cl. G06F 3/0483; G06F 3/0488; H04W 4/16; G06F 3/0485; H04M 1/725; G06F 3/0484; G06F 3/0482

(52) U.S. Cl. CPC G06F 3/0483; G06F 3/04842; G06F 3/04883; G06F 3/0482; G06F 3/0485; H04M 1/72583; H04W 4/16; G06F 2203/04803

(57) ABSTRACT

Mechanisms are provided herein which accommodate the handling of multiple communication sessions on a communication platform using an active call view display. In particular, when a single and/or multiple calls are connected with a communication platform, a user interface can provide a dynamic active call view with call stack and feature attributes for simple management and control of the one or more calls. The multiple calls can be managed independently and a manner most productive with a user while improving user experience.

### FIELD OF THE DISCLOSURE

The present disclosure is generally targeted at applications running on computing platforms and more specifically, toward handling one or more communication sessions through a user interface on the communication platform.

### BACKGROUND

In today's mobile society, the need to be constantly connected has become a virtual necessity. As such, users often depend on their communication device for quick and easy access to individuals or entities. Often times, this may require the need for one or more calls to be actively and simultaneously connected to the communication device.

Typically, when a user has an incoming call, a pop-up screen or similar notification indicator is presented. The pop-up screen will generally provide the user with the option to accept or reject the call. Sometimes, if there is currently an active call in progress, the initial call can be placed on hold. Nevertheless, managing multiple calls can be cumbersome and current methods such as pop-ups are quite limiting and frustrating at times.

Thus, a number of issues are arising from this scenario. One such issue is the inability for a user to quickly and easily switch between multiple active calls. Another issue is the absence of a centralized location for viewing and managing multiple calls. This is especially true when needing to initiate and merge more than one call. Some of the complexities with multiple calls on the same device include contention between applications that must be in the foreground (e.g., on iOS there can only be one), the contention can be between applications for the same speaker/microphone, and the limited screen real estate. Still another issue is the inconvenience presented to a user who desires keep a call on the line, switch between the calls, or access call features, tasks that are generally not possible, not optimized for small screen devices or small application windows or take numerous steps making the process quite cumbersome and difficult to follow.

### SUMMARY

Embodiments of the present disclosure proposed herein provide one or more mechanisms to maintain and display multiple communication threads using an active call view. Although embodiments of the present disclosure will be described in connection with managing multiple “active calls”, it should be appreciated that embodiments of the present disclosure are not so limited. In fact, the concepts disclosed and claimed herein can be used to manage multiple communication threads of different types, some of which may or may not correspond to active voice calls. For instance, embodiments of the present disclosure can be used to manage one or multiple video calls, voice calls, text chats, emails threads, multi-media interactions, web-chats, or combinations thereof. Thus, the use of the term “call” should not be construed as limiting the present disclosure to the management of voice calls only.

In some embodiments, the active call view can provide a user with the ability to quickly access call features and view details regarding current calls. In some embodiments, the active call view user interface can include a call stack attribute which allows a user to have a dynamic notification as to the status of in-progress calls. In other embodiments, the peripheral active call view provides a sliding window to show and activate other call appearances such as the features view associated with a call on hold, a call on mute, etc.

In accordance with at least some embodiments of the present invention, a method is provided that generally comprises:
a memory;
a processor configured to:
   cause an active call view to be displayed on a display screen, wherein the active call view presents information regarding a current call, and wherein the active call view further presents a call stack attribute and a features attribute associated with the active call; and
   manage the one or more calls using one or more of the call stack attribute and the features attribute.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

### BRIEF DESCRIPTION OF THE DRAWINGS

The present disclosure is described in conjunction with the appended figures, which are not necessarily drawn to scale:

FIG. 1 depicts a user interaction with multiple wireless communication devices;

FIG. 2 depicts a wireless communication device;

FIG. 3 depicts a wireless communication device with an active call view;

FIG. 4 depicts an illustrative use of a call stack attribute;

FIG. 5 depicts screen transitioning from an active call view to a call stack view;

FIG. 6 depicts multi-call management using the call stack attribute;

FIG. 7 depicts multi-call management using a contacts option;

FIG. 8 depicts an exemplary use of a features attribute; and

FIG. 9 depicts a flow chart illustrating multiple call management using an active call view.

### DETAILED DESCRIPTION

The ensuing description provides embodiments only, and it is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

While embodiments of the present disclosure will be primarily described in connection with a user interface on a wireless communication device, it should be appreciated that embodiments of the present disclosure are not so limited.

Various aspects of the present disclosure will be described herein with reference to drawings that are schematic illustrations of idealized configurations. It should be appreciated that while particular user interface arrangements and configurations are described herein, embodiments of the present disclosure are not limited to the illustrative display configurations and/or user interface depictions and descriptions. Specifically, it should be appreciated that features, functions and various views may be replaced or added to achieve a similar function without departing from the scope of the present disclosure.

Presented herein are embodiments of a system and method that solve the drawbacks associated with receiving and transmitting information regarding multiple calls. The embodiments may relate to a communication device. The overall design and functionality of the system described herein is, as one example, to provide a more efficient means for a device to present and manage multiple calls using a user interface for display of the multiple calls on a call stack view.

Embodiments provide a novel mechanism that facilitates a simple and efficient process for managing one or more cellular calls on a wireless communication device. The embodiments generally reduce the complexity involved in connecting a wireless communication device with one or more wireless devices. As a result, an easy way to move between calls is presented providing a user with peripheral views for toggling between active calls. Other advantages exist as will be discussed herein.

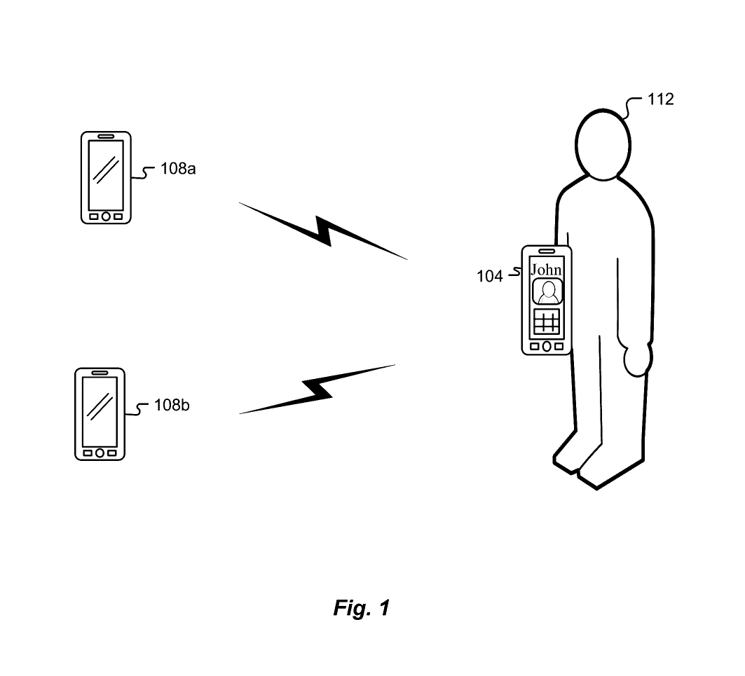

A general depiction of a user 112 employing a communication device 104 to interact with other devices 108a, 108b is illustrated on FIG. 1. The devices 108a, 108b can include but are not limited to mobile phones, mobile computers, smart phones, laptops, netbooks, personal digital assistants, tablets, Personal Computers (PCs), and can include any wired or wireless device and/or interface, etc., which can connect over a communication network. Communication between the communication device 104 and the other devices 108a, 108b can occur simultaneously or at independent instances of time. Furthermore, the communication between the device 104 and different devices 108a, 108b may be on a common communication session (e.g., a conference call) or different communication sessions (e.g., two independent calls, one call and one chat, one cellular call and one WebRTC call, desk phone, voice mail server, etc.).

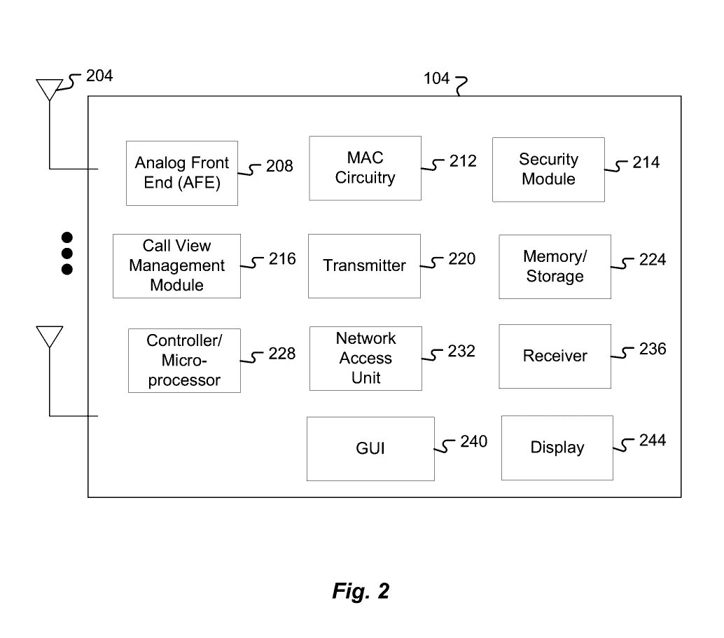

During the communication between the communication device 104 and the two or more devices 108, one or more of the calls can be affected or even dropped. Additionally, if by chance a call is not dropped, the ability to merge or add a call to the line, can be a challenge. In accordance with some embodiments, presenting a user interface for managing multiple calls on the communication device 104 can provide beneficial. Further, presenting a method to optimize numerous calls is an advantage that is described below in conjunction with FIGS. 2-9 in the form of a call view management module and methods/processes depicting how to use and navigate through the user interface.

An example of a communication device architecture is shown in FIG. 2. The communication device 104 can comprise circuitry and/or software that conduct various operations. The operations can include, but are not limited to, conducting calls, synchronizing with other devices, opening multiple applications, presenting information through audio and/or video means, taking pictures, handling multiple calls, etc. The communication device 104 can be any type of computing system operable to conduct any type of operation described herein. As an example, the communication device 104 can be a mobile phone which includes and interacts with various modules and components 204-244 as shown in FIG. 2.

The communication device 104 can have one or more antennas 204 used in signal transmission. The signal transmission can include communications such as multi-input multi-output (MIMO) communications, Bluetooth®, Device to Device (D2D) communications, NFC, etc. The antennas 204 can include, but are not limited to directional antennas, omnidirectional antennas, monopoles, patch antennas, loop antennas, microstrip antennas, dipoles, and any other antenna suitable for communication transmission.

The communication device architecture includes a transmitter 220 and receiver 236 which are use for data transmission and reception between one or more communication devices 104, using the one or more antennas 204. When the signal is received at the antenna, the signal will generally progress to the Analog Front End (AFE) 208. The AFE 208 is a module that sits between the antennas and the analog-to-digital (A/D) converter, for signal conditioning and digital processing. In some instances, the A/D is part of the AFE 208.

Included in the communication device architecture is also a controller/microprocessor 228 and memory/storage 224. These components are commonly known in the art and are configured to perform those functions as known and understood by those skilled in the art. For example, the controller/microprocessor 228 is used for processing the digital data from the AFE 208 and can include Application Specific Integrated Circuits (ASICs), digital signal processors, controllers, logic circuits, gate arrays, specific purpose computers, and the like. The memory/storage 224 is used store and retrieve instructions in connection with the controller/microprocessor 228 and can include temporary or long term storage as well as RAM, ROM, DRAM, SDRAM, and other storage devices and media.

The MAC circuitry 212 and Network Access Unit 232 are other modules located within the architecture of the wireless communication device 104. The Network Access Unit 232 can work as a medium used for connectivity between devices and can work in conjunction with at least the MAC circuitry 212. The MAC circuitry 212 can be arranged to contend for a wireless medium and can aid in configuring the packets and frames that will be transmitted over the communication medium.

The communication architecture can also contain a security module 214. The security module can contain information including but not limited to network parameters, WEP and WPA security access keys, network keys, and other codes needed to communicate and access the networks communicating with the wireless communication device 104.

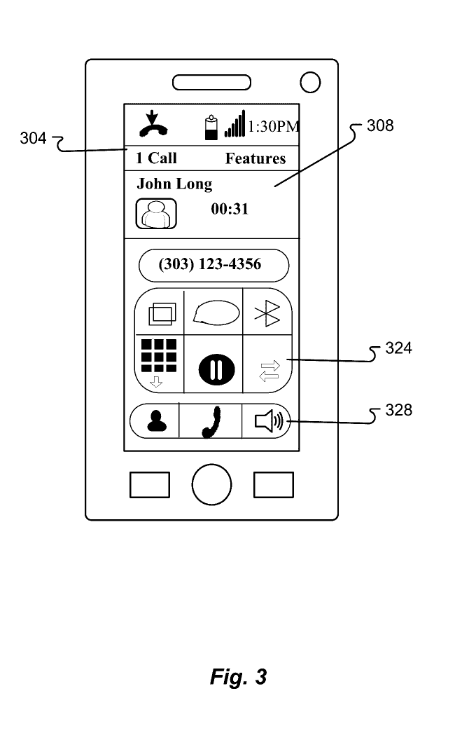

For error handling, as mentioned above, the communication device 104 can contain a display 244, a Graphical User Interface (GUI) module 240 and a Call View Management module 216. The GUI module 240 is a module that can be used for managing, manipulating and/or controlling the user interface presented below and in conjunction with FIGS. 3-9. In particular, the GUI module 240 may be configured to automatically adapt properties of the user interface when it is determined that one or more cellular calls are received at the communication device. The GUI module 240 can also work in conjunction with or independently from the Call View Management module 216. The Call View Management module 216 is a module that can work in conjunction with the controller/microprocessor 228 and memory/storage 224 to manage, store and retrieve the various call properties received at the wireless communication device 104.

The modules described and others known in the art can be used with the communication device 104 and can be configured to perform the operations described herein and in conjunction with FIG. 1 and FIGS. 3-9.

FIG. 3 illustrates a communication device 104 in an active call view 308. The active call view 308 is a user interface used to enable a user 112 to interact with the wireless communication device 104. The active call view 308 can provide a display for interactions involving a cellular communication between devices.

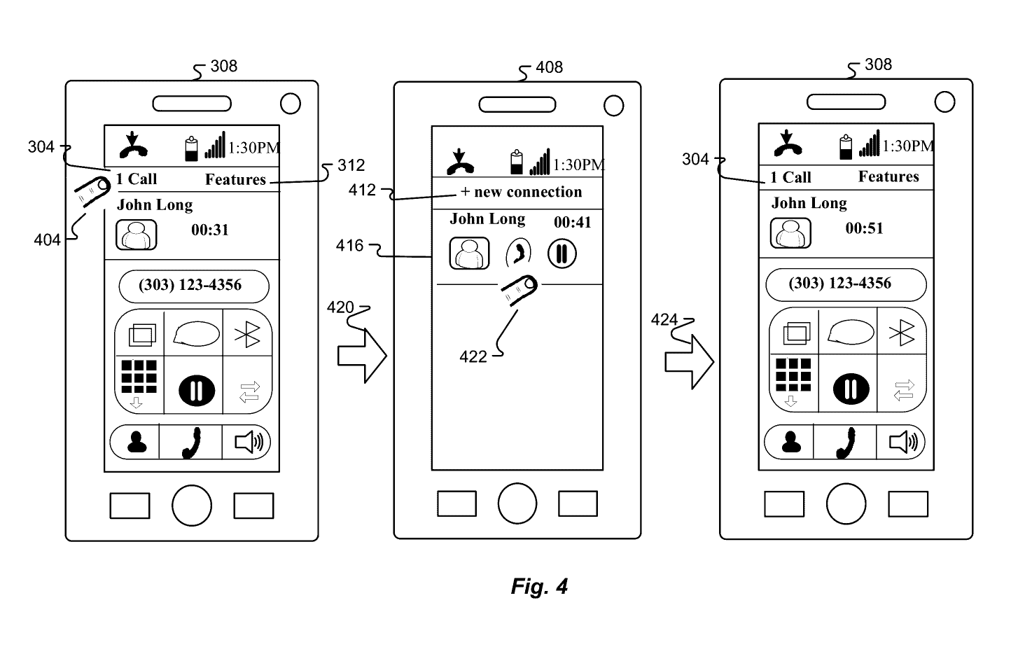

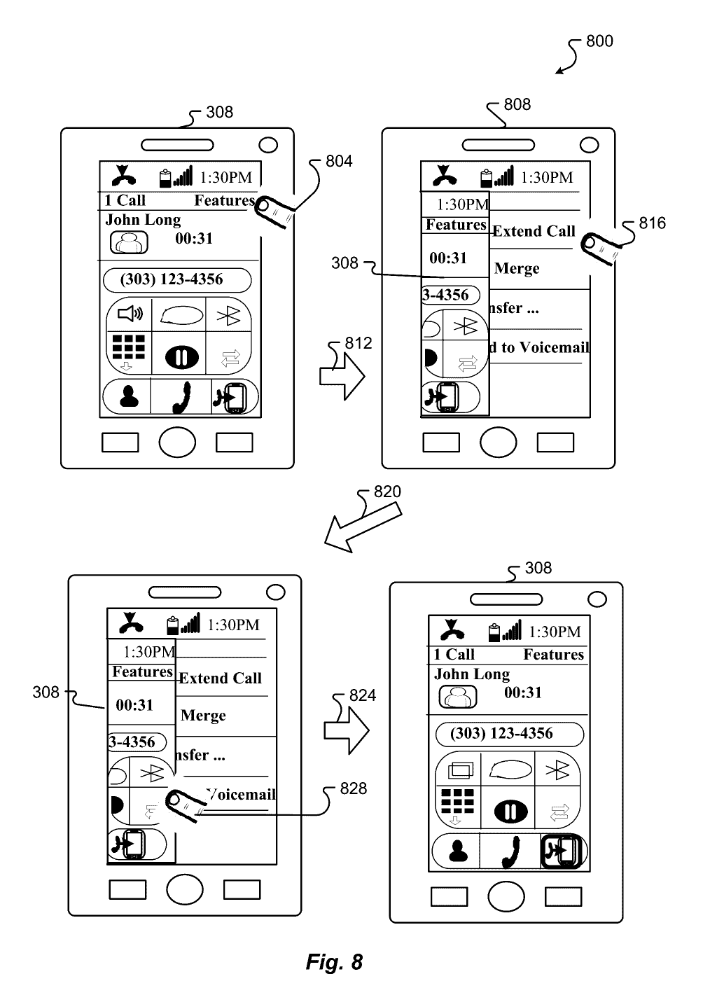

FIG. 3 is an illustrative embodiment of an active call view 308 with a call stack attribute 304 and features attribute 312. The call stack attribute 304 located within the active call view 308 is a function within the user interface that provides a user 112 with immediate information pertaining to the number of calls currently on the communication device 104. Specific details regarding the call attribute functionality are described below and in conjunction with FIGS. 4-9. The features attribute 312 is another component within the active call view 308 user interface wherein a user 112 has quick access to call features. Details regarding the use and access of the features attribute 312 are detailed throughout and specifically in conjunction with FIG. 8.

Additional attributes and options provided by the active call view 308 can include options 324,328 for communicating over the cellular network such as, connecting the call over a Bluetooth device, putting the call on speaker or hold, disconnecting from the call, and even merging the call with other calls.

FIG. 4 depicts an illustrative use of a call stack attribute. As illustrated in FIG. 3, the call stack attribute 304 is a feature that is available through the active call view 308. Additionally or alternatively, the call stack attribute 304 can be accessed through other GUIs (i.e. dial view, in call view, setting view, etc.) within the wireless communication device 104. The active call view 308 presents the user with information regarding the status of a current/in-progress call, options available for managing the call, features (under features 312 attribute), and information regarding the number of calls currently on the line with the wireless communication device 104 (call stack attribute 304). As an example, the call stack attribute 304 can identify a single call with John Long who just recently connected with the communication device 104.

A feature that is available through the call stack attribute 304, is the ability to navigate the user 112 to a secondary screen where a call stack view 408 presents a user 112 with a listing of the current calls, if multiple calls are simultaneously in progress. As an example, FIG. 4 illustrates a user 112 selecting 404 the call stack attribute 304 which prompts 420 the display of a new user interface, the call stack view 408. The call stack view 408 is a user interface that presents a user 112 with the ability to easily identify all calls in which the communication device 104 is currently involved. Additionally, the call stack view 408 provides the user 112 with the ability to start a new call if he/she desires. As illustrated in FIG. 4, the call stack view 408 includes a listing of the current call(s) (i.e., John Long) in the connection listing area 416, along with a display of the length and current status of the call.

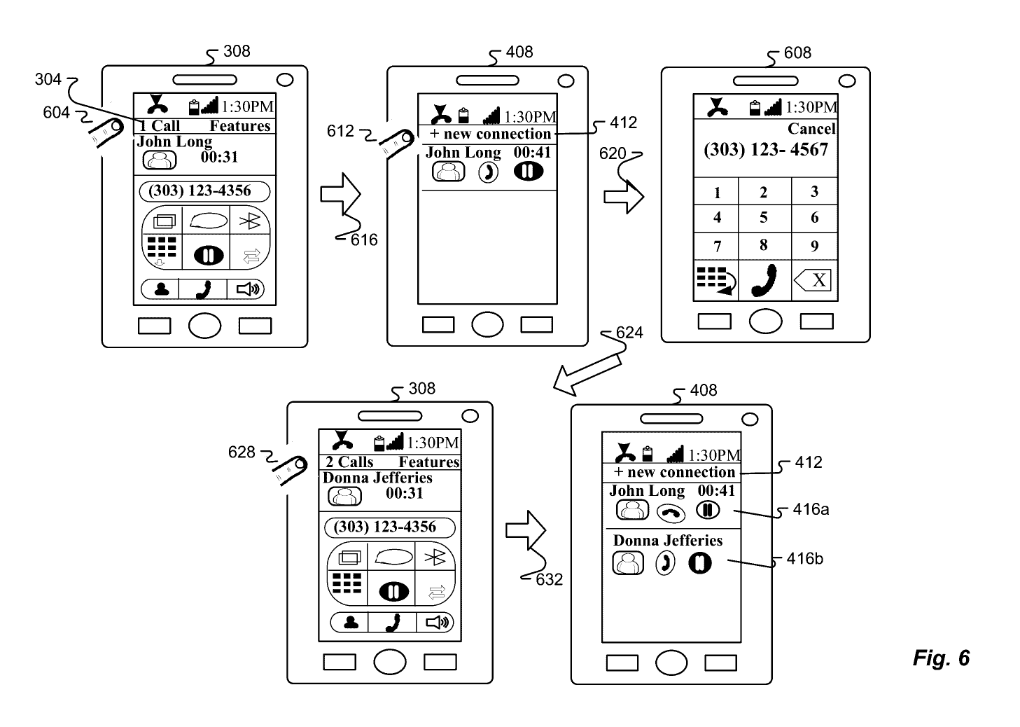

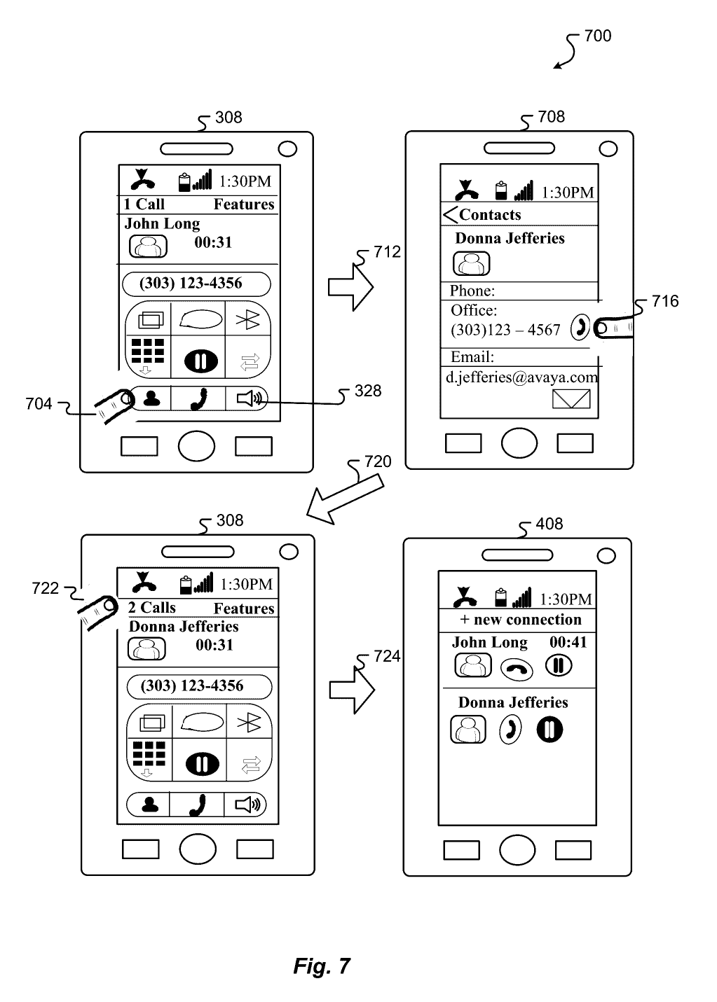

The call stack view 408 also provides a user 112 with easy access to starting a new call using the new connection feature 412. A selection of this feature redirects a user 112 to a dialpad where the call is made and connection established or to a connection set-up area where contacts can be added to establish connection with them. If, no additional calls are desired at the moment, a user 112 may simply select 422 the connections listing area 416 of the desired call, the user would like to return to. In one example, the user 112 selects 422 the connection listing area 416 pertaining to John Long. Upon making the selection, the user 112 is returned 424 to John's active call view 308. Notice that in this instance, no additional connections were added, as such the call stack attribute 304 indicates “1 Call.” Alternatively, if the user would have selected the new connection feature 412 in the call stack view 408 and connected with a second individual/entity, the call stack attribute 304 would be updated to “2 Calls.” The same update to the call stack attribute 304 would also occur had a call been received while on the line with John. Further details regarding the new connection feature 412 are detailed below and in conjunction with FIG. 6 and FIG. 7.

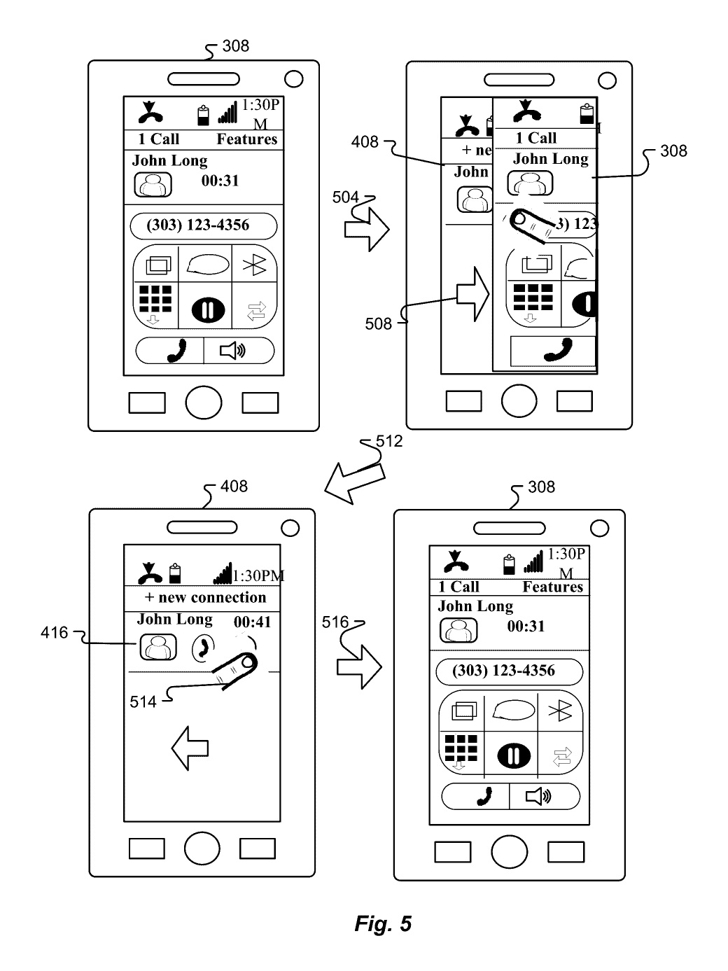

FIG. 5 illustrates an embodiment of screen transitioning from active call view 308 to a call stack view 408. As described above, the active call view 308 provides a user with the ability to reach a call stack view 408 via the call stack attribute 304. Alternatively, a user 112 can reach the call stack view 408, by means of a swipe gesture. That is, a user 112 in call stack view 408 transitions 504 to the active stack view 408 by swiping 502 from left-to-right on the edge of the active call view 308, exposing the call stack view 408 as the window slides across 508. As the windows complete transition 512, full display of call stack view 308 is achieved. Note that the swiping gesture and direction is not limiting as other gestures or directions may be used to transition between the peripheral views. For example, a tap, a drag, a tap-and-drag, a pinch, a pinch-and-expand are all non-limiting examples of gestures that can be used. Additionally or alternatively, the windows (e.g., active call view 308, call stack view 408, etc.) can appear as sliding windows, pop-up windows, cascaded windows, stacked windows, rolodexed windows, etc.

At the call stack view 308, the user 112 has the option to pause the call, add a call, receive a call, and generally get information on the one or more calls on the communication device 104. In addition, the call stack could include calls that are active on the local device or remote line, or appearance that represents calls on other devices. As an example, this call stack view can be used to join or bridge onto a call on another device that shares the same line appearance. A return to the active call view 308 once the user 112 is done with the call stack view 308, is possible through a tap 514 on the connections listing area 416. Swiping, tapping, pinching, dragging and other gestures are also possible gestures available for the transition 516 back to the active call view 308.

If a user 112 desires to add a connection to the current call, the call stack view 408 offers the new connection feature which provides such an option. To illustrate the use of this feature, FIG. 6, depicts multi-call management using the new connection feature 412 which derives from the call stack attribute 304 from the active call view 308. The process of initiating a new call begins at the active call view 308 user interface, where the call stack attribute 304 resides. By selecting 604 the attribute, a user 112 is transitioned 616 to the call stack view 408. At the call stack view 408, as previously described, a user 112 is able to quickly and easily view a listing of the current calls as well as initiate a new call. A new call begins with a selection 612 of the new connection option 412. The new connection option 412 provides a user 112 with a convenient way to connect with individuals and/or entities with a single push of a button. Upon selecting 612 the new connection option 412, the call stack view 408 transitions 620 to a dialpad view 608. At the dialpad view 608, a phone call is initiated and connected 624 and the previous call is automatically put into a held state. The new connection presents a new active call view 308 where the call can be managed whether by transitioning to Bluetooth, speaker, text, merged, etc. As the new call view 308 appears, the call stack attribute 304 is updated to reflect the now secondary call on the line. This call stack attribute 304 will dynamically update as more or less calls are connected with the wireless communication device 104.

As described above and in conjunction with FIG. 3, the active call view provides management features accessible through the option areas 324,328, call stack attribute 304 and the features attribute 312. The user 112 can manipulate the call as desired, if for example, the user wants to view a listing of the current calls, selection 628 of call stack attribute 304, will transition 632 to the call stack view 408. At the call stack view, the connections listing area has expanded to include both calls 416a, 416b. This type of update will dynamically occur as more or less calls are connected. If additional calls are desired, the new connection option 412 can again be selected. The call stack may also show other types of calls such as those from bridged or shared line appearances where a call may be active on another device, but appears on the communication device in the call stack and may be picked up by the communication device user.

In making multiple connections, various options are available for making those connections. For example, FIG. 7 provides an alternative to the multi-call connection presented in FIG. 6 where the multi-call connection occurs using the contacts option. To initiate a secondary call the contacts option located within the option area 328 of the active call view 308 is selected. The selection of the contact option prompts 712 display of the contact view 708 where the contact information is displayed and input 716 on the call button initiates the call.

As the call is connected 720, the active call view 308 appears. The active call view 308 again includes details on the call, the features attribute 312 and the call stack attribute 304. The call stack attribute 304 being a dynamic feature automatically updates the N calls, (i.e. from “1 Call” to “2 Calls”) to reflect the addition of the call. Alternatively, if a call had disconnected, the N call would update accordingly. Thereafter, by selecting on the call stack attribute 720, the user 112 gets an updated view of the call stack view 408 with a listing of the now current calls with corresponding connections listing areas 416a, 416b.

In one exemplary embodiment, the wireless communication device user 112 is on the line with John Long. To display the connection, the active call view 308, user interface is presented with the call stack attribute 304 indicating the “1 Call.” User 112 decides to add a call and selects 704 the contacts option, which prompts display of the contact list view and the user selects Donna Jefferies and gets the contact view 708. At the contact view, the user 112 connects 716 with Donna Jefferies. Donna Jefferies' active call view 308 appears as the connection occurs. A depression 722 on the now updated “2 Call” call notification attribute 304 prompts 724 display of the call stack view 408 with a listing of both John's and Donna's call details.

FIG. 8 depicts an illustrative use of the features attribute 312. The features attribute 312 is located within the active call view 308 user interface. Selecting 804 on the features attribute 312 provides 812 a user with features view 808. As depicted on FIG. 8, as the user 112 selects the features attribute 804 and in response the active call view 308 slides left exposing a features view 808. Alternatively, the user 112 displays the features view by dragging the right of the active call view 308 to the left. The features view 808 can also be displayed as a pop-up, as a stack window, as a cascading window, in a carousel like fashion, etc. The carousel like fashion can include display of the windows in a rolodex fashion. The features view 808 is a user interface, which presents a user 112 with options for managing a call. These options can include but are not limited to, transfer call, merge/conference, send to voicemail, hold, mute, etc.

The user 112 can select the appropriate features he/she is interested in using and then navigates back 820 to the active call view. To transition back to the active call view 308, the user 112 can select 828 any part of the active call view 308 that remains exposed. Alternatively, the user 112 can select a Back option which can be available from the features view 808 (not shown). The input by the user 112 will cause the active call view 308 to fully consume the screen either by sliding, popup, stack, cascade or rolodex display.

For example, we have a first call with John Long. User 112 is interested in making a second connection with Donna Jefferies. To combine both calls to one conversation, the user 112 can reach for the features attribute 312 on his active call view 308 to conference Donna Jefferies into the conversation. The features attribute 312 prompts the transition into the features view 808 where the user 112 can select 816 the merge option to combine John and Donna's conversation. Upon finishing with the features, the user can simply return to the active call view which will display be displayed when any part of the exposed active call view 308 is selected.

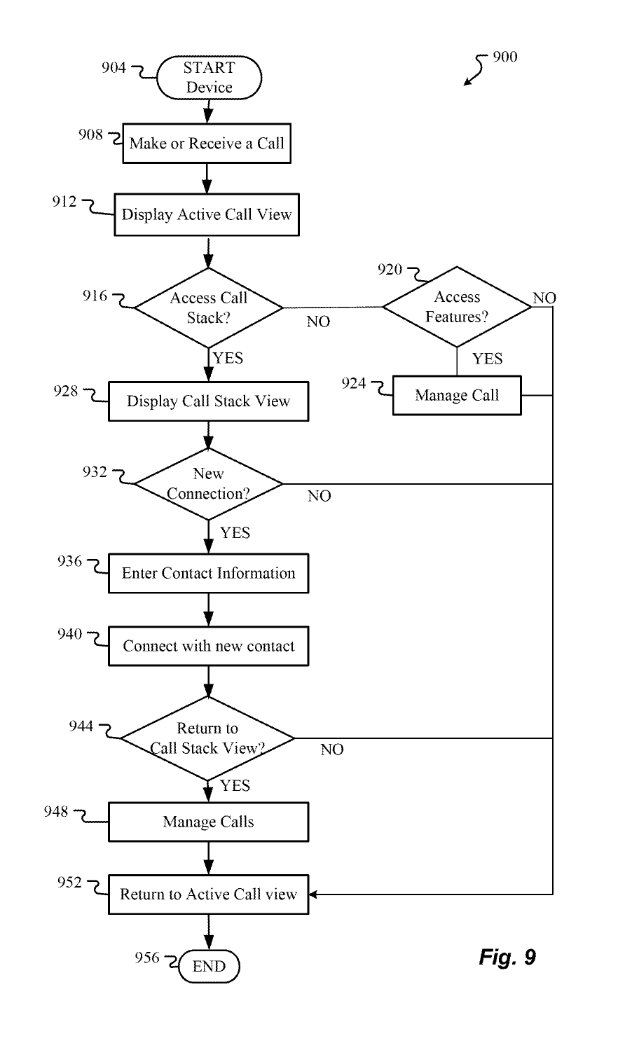

FIG. 9 outlines an illustrative flowchart illustrating multiple call handling using an active call view user interface. In particular, execution of multi-call handling begins at step 904 and continues to step 908. In step 908 a communication device receives or makes a call. The call can come from at least one wireless device and/or derive from the wireless communication device.

The call received or made, prompts the display of an active call view on step 912. In the active call view 912, the opportunity exists to stay in the call as is, access the call stack at step 916 or access the call features at step 920. In step 916, a user is presented with the option to navigate via the call stack attribute to the call stack view to step 928. Access to the call stack view is also available via hand gestures including swiping, tapping, dragging, etc.

If a user is not interested in moving forward to a call stack view, the option exists to continue to the features view to access the call features. Access to the call features, as provided above an in conjunction with FIG. 8, allows the user to manage the current call(s) including merging the multiple calls so as to provide one unified conversation. If a user is interested in manipulating the call(s), the process moves to step 924, where merger (and/or other actions available in the features view) can occur. In the alternative, if the user has no interested in navigating through the features view, return to the active call view in step 952 occurs.

Back at step 928, the decision was made to continue with the call stack view and display of that user interface is presented. In the call stack view, the user has access to a listing of the current connections located within the connections listing area and the option in step 932, to begin a new conversation. If a new connection is not required or desired, the wireless communication device can return to the active call view on step 952. However, if adding a new conversation is preferred, the process continues to step 936. The new connection can be accessed in one of a numerous ways including using the new connection option or through the use of the contacts option in step 936. The connection is made in step 940.

With multiple calls on the line, the option exists to return to the call stack view in step 944. By returning to the call stack view, alternatives are available as to the management of the multiple calls. Step 948 presents those options where access to the features view so as to merge the calls, drop a call, pause a call, etc., exists. Once those actions are complete, a return to the active call view occurs in step 952. If however, the wish is to skip the call stack view, return to the active call view is immediately available as the process skips to step 952 and ends at step 940.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed:

1. A communication device, comprising:
a memory;
a processor configured to:
cause an active call view to be displayed on a display screen, wherein the active call view presents information regarding a current call, and wherein the active call view further presents a call stack attribute and a features attribute associated with the active call; and
manage one or more calls using one or more of the call stack attribute and the features attribute.

2. The communication device of claim 1, wherein the call stack attribute dynamically updates according to a number of active calls.

3. The communication device of claim 1, wherein selection of the call stack attribute presents a call stack view.

4. The communication device of claim 1, wherein the active call view transitions to the call stack view when a first gesture is detected.

5. The communication device of claim 3, wherein the call stack view comprises a presentation of the one or more calls, information related to the one or more calls and relationship between the one or more calls.

6. The communication device of claim 3, wherein the call stack view transitions to the active call view when a connections listing area is selected, and wherein the call stack view can display an active call from a shared line.

7. The communication device of claim 6, wherein the connections listing area provides a listing of the current calls and wherein the connections listing area automatically updates with the addition and/or drop of a call.

8. The communication device of claim 1, wherein selection of the features attribute presents a features view.

9. The communication device of claim 1, wherein the call view transitions to the features view in response to one or more gestures.

10. The communication device of claim 7, wherein the features view enables two or more calls to be merged.

11. The wireless communication device of claim 8, wherein a sliding motion provides the transition between two or more of the features view, call stack view, and active call view occurs.

12. The wireless communication device of claim 8, wherein at least two or more of the features view, call stack view, and active call view are displayed in any one or more of side-by-side, stacking, cascading, or rolodexing layout.

13. A method comprising:
displaying, by the processor, an active call view on a display screen, wherein the active call view presents information regarding a current call, and wherein the active call view further displays a call stack attribute and a features attribute associated with an active call; and
managing, by the processor, one or more calls using one or more of the call stack attribute and the features attribute.

14. The method of claim 13, wherein the call stack attribute dynamically updates according to a number of calls connected with a device.

15. The method of claim 13, wherein selection of the call stack attribute presents a call stack view on the device, wherein the call stack view includes one or more calls on a second device.

16. The method of claim 15, wherein a new call is initiated from the call stack view.

17. The method of claim 15, wherein the call stack view transitions to the active call view when a connections listing area is selected, wherein the connections listing area provides a listing of the current calls and wherein the connections listing area automatically updates with the addition and/or drop of a call.

18. The method of claim 13, wherein selection of the features attribute presents a features view.

19. A non-transitory computer readable medium having instructions stored thereon that when executed by at least one processor of a device perform a method comprising:
displaying, by a processor, an active call view on a display screen, wherein the active call view presents information regarding a current call, and wherein the active call view further presents a call stack attribute and a features attribute associated with an active call; and
managing, by a processor, one or more calls using one or more of the call stack attribute and the features attribute.

20. The non-transitory medium of clam 19, wherein the call stack attribute dynamically updates according to a number of calls connected with a device, and wherein selection of the call stack attribute presents a call stack view, wherein the call stack view comprises a presentation of the one or more calls simultaneously, information related to the one or more calls and relationship between the one or more calls.
